(19) United States
(12) Patent Application Publication
(10) Pub. No.: US 2018/0266842 A1
(43) Pub. Date: Sep. 20, 2018

(54) TECHNIQUES FOR ADJUSTING THE LEVEL OF DETAIL OF DRIVING INSTRUCTIONS

(71) Applicant: HARMAN INTERNATIONAL INDUSTRIES, INCORPORATED, Stamford, CT (US)

(72) Inventors: Davide DI CENSO, Oakland, CA (US); Stefan MARTI, Oakland, CA (US); Jaime Elliot NAHMAN, Oakland, CA (US); Mirjana SPASOJEVIC, Palo Alto, CA (US)

(21) Appl. No.: 15/541,466

(22) PCT Filed: Jan. 8, 2016
(86) PCT No.: PCT/US2016/012751

§ 371 Date: Jul. 3, 2017

Related U.S. Application Data
(60) Provisional application No. 62/101,862, filed on Jan. 9, 2015.

(51) Int. Cl. G01C 21/36; G01C 21/34

(52) U.S. Cl. CPC G01C 21/3641; G01C 21/3492

(57) ABSTRACT

A navigation system is configured to monitor various contextual data associated with the driving and navigation of a vehicle, and to scale the level of detail of driving instructions based on that contextual data. In doing so, the navigation system may estimate a level of familiarity that a driver of the vehicle has with a current route, and then identify and/or determine a degree to which the driver of the vehicle diverges from the current driving instructions. Based on either one of, or both, of the familiarity level and the divergence level, the navigation system scales the level of detail of the driving instructions so that the driver is provided with an appropriate amount of information.

### CROSS-REFERENCE TO RELATED APPLICATIONS

This application claims the benefit of U.S. provisional patent application titled “Fuzzy Navigation System,” filed on Jan. 9, 2015 and having Ser. No. 62/101,862. The subject matter of this related application is hereby incorporated herein by reference.

### BACKGROUND

### Field of the Disclosed Embodiments

The disclosed embodiments relate generally to navigation systems and, more specifically, to techniques for adjusting the level of detail of driving instructions.

### Description of the Related Art

Conventional navigation systems provide driving instructions to assist drivers in navigating a vehicle from one location to another location. During driving, navigation systems generally output two forms of information to the driver to guide navigation. The first is a visual map illustrating some or all of the route being traveled. The second consists of audio and/or visual driving instructions along the route being traveled. The audio/visual driving instructions could be, for example, written instructions displayed on a screen or spoken instructions output via a speaker system in the vehicle.

One well-understood drawback of conventional navigation systems is that the systems do not account for the level of familiarity drivers have with various portions of the routes being traveled. Consequently, conventional systems tend to provide driving instructions having the same level of detail for all portions of all routes. Thus, when a portion of a given route is well-known to a driver of a vehicle, the navigation system still outputs unnecessarily detailed driving instructions to the driver. For example, a particular driver could always perform the same sequence of turns to exit the driver's neighborhood. With a conventional navigation system, the driver would be presented with the same sequence of driving instructions representing that same sequence of turns, despite the fact that this sequence is very well known to the driver.

Situations like the above example are problematic because drivers oftentimes become annoyed and distracted by conventional navigation systems that provide redundant and/or unhelpful driving instructions. When drivers become annoyed or distracted, driving safety can become compromised. Another potential problem is that drivers may simply turn off navigation systems to avoid listening to irrelevant and/or unhelpful driving instructions. Without their in-vehicle navigational systems, those same drivers may subsequently become lost when entering unfamiliar driving territory.

As the foregoing illustrates, techniques for providing more relevant driving instructions to drivers would be useful.

### SUMMARY

One or more embodiments set forth include a non-transitory computer-readable medium storing instructions that, when executed by a processor, configure the processor to provide driving instructions to a driver of a vehicle, by performing the steps of generating an initial set of driving instructions for navigating the vehicle along a route, generating contextual data associated with navigating the route, scaling a level of detail associated with the initial set of driving directions based on the contextual data to generate a second set of driving instructions for navigating the vehicle along the route, and transmitting the second set of driving instructions to the driver.

At least one advantage of the disclosed embodiments is that the driver of the vehicle is not subjected to superfluous driving direction detail while driving that could otherwise be distracting. Thus, scaling the level of detail in one or more of the manners described herein may provide a safer approach to assisting drivers with navigation.

### BRIEF DESCRIPTION OF THE SEVERAL VIEWS OF THE DRAWINGS

So that the manner in which the recited features of the one more embodiments set forth above can be understood in detail, a more particular description of the one or more embodiments, briefly summarized above, may be had by reference to certain specific embodiments, some of which are illustrated in the appended drawings. It is to be noted, however, that the appended drawings illustrate only typical embodiments and are therefore not to be considered limiting of its scope in any manner, for the scope of the disclosed embodiments subsumes other embodiments as well.

FIGS. 1A-1C illustrate elements of a navigation system configured to implement one or more aspects of the various embodiments;

FIGS. 2A-2B illustrate exemplary techniques for changing the level of detail of driving instructions, according to various embodiments;

FIGS. 3A-3B illustrate exemplary driving instructions generated by the navigation system of FIG. 1A and having different levels of detail, according to various embodiments;

FIGS. 4A-4B illustrate exemplary driving instructions scaled by the navigation system of FIG. 1A and having dynamic levels of detail, according to various embodiments;

FIG. 5 is a flow diagram of method steps for scaling the level of detail of driving directions based on contextual data, according to various embodiments;

FIG. 6 is a flow diagram of method steps for scaling the level of detail of driving directions based on a familiarity level associated with a driver of a vehicle, according to various embodiments;

FIG. 7 is a flow diagram of method steps for scaling the level of detail of driving directions based a degree to which a driver of a vehicle diverges from the driving directions, according to various embodiments; and

FIG. 8 is a flow diagram of method steps for scaling the level of detail of driving directions based on both a familiarity level associated with a driver of a vehicle and a degree to which the driver diverges from the driving instructions, according to various embodiments.

### DETAILED DESCRIPTION

In the following description, numerous specific details are set forth to provide a more thorough understanding of certain specific embodiments. However, it will be apparent to one of skill in the art that other embodiments may be practiced without one or more of these specific details or with additional specific details.

### System Overview

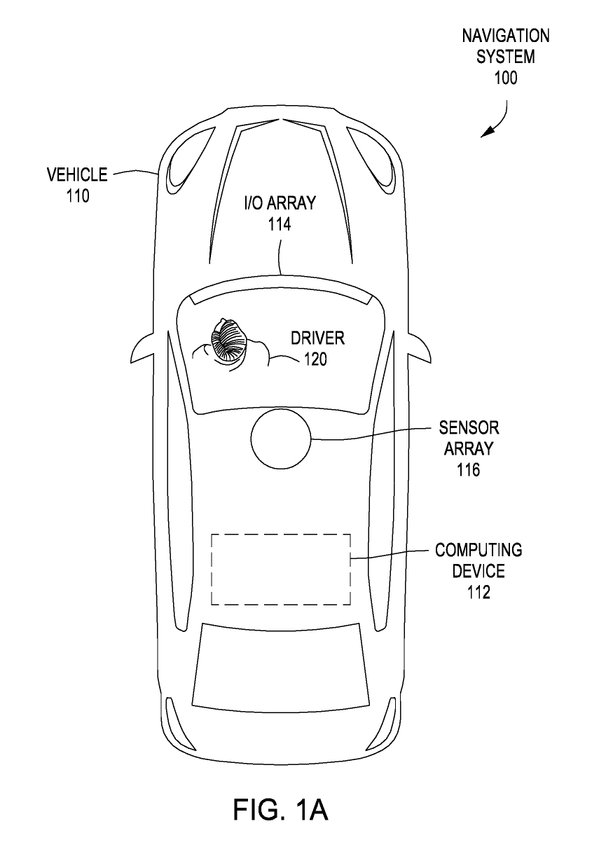

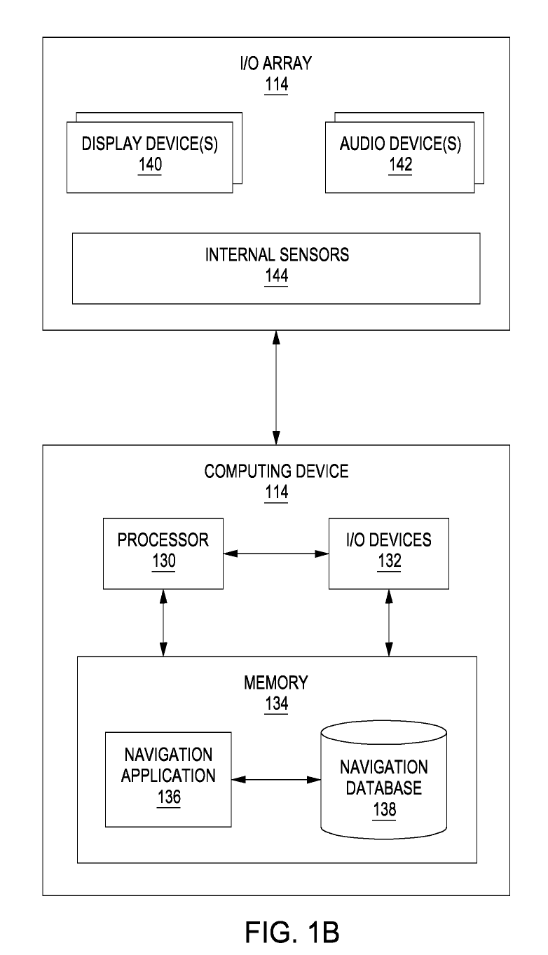

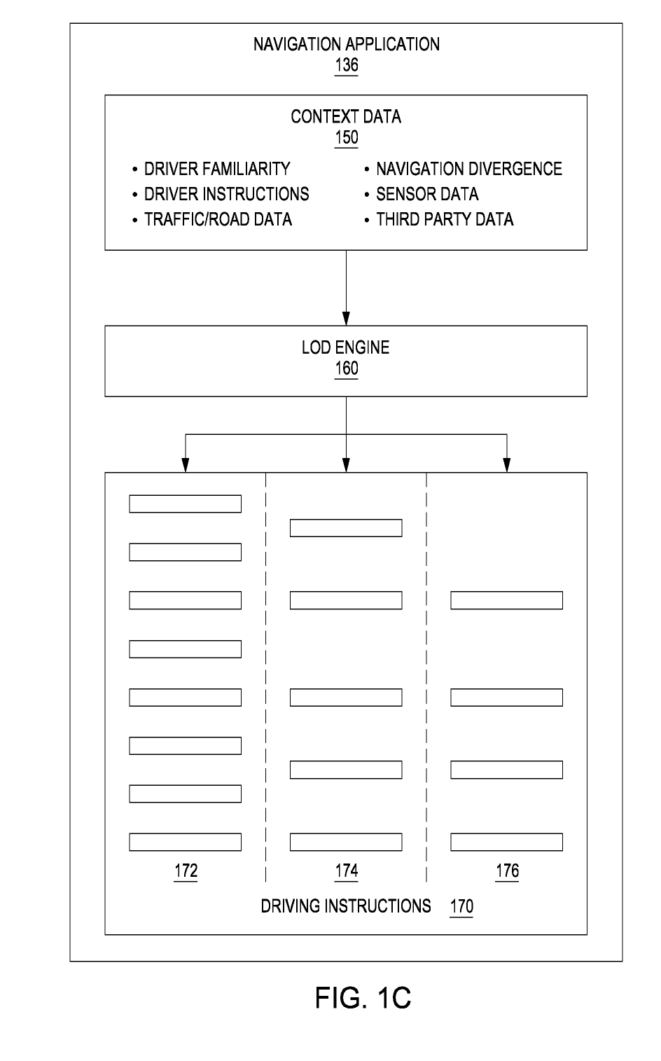

FIGS. 1A-1C illustrate elements of a navigation system configured to implement one or more aspects of the various embodiments. As shown in FIG. 1A, a navigation system 100 resides within a vehicle 110 that is occupied by a driver 120. Navigation system 100 includes a computing device 112, an input/output (I/O) array 114, and a sensor array 116. Computing device 112 is configured to manage the overall operation of navigation system 100, and is described in greater detail below in conjunction with FIG. 1B. I/O array 114 includes various input elements for monitoring driver 120 and various output elements for outputting video data, audio data, haptic data, and other types of data to driver 120. I/O array 114 is described in greater detail below in conjunction with FIG. 1B. Sensor array 116 includes various outward-facing sensors that may be implemented to collect environmental data derived from a region proximate to vehicle 110. Sensor array 116 could be used, for example, and without limitation, to provide sensor data for automated driving of vehicle 110.

Navigation system 100 is configured to provide driving instructions to driver 120 that may assist driver 120 in navigating vehicle 110 from one location to another. The driving instructions may include a route plotted on a visual map, a set of written instructions, or a set of spoken instructions, among other possibilities. In operation, navigation system 100 receives input from driver 120 that represents a starting location and a destination location. In one embodiment, navigation system 100 may estimate the starting location and/or destination location, or receive such estimates from a system configured to predict those locations based on common driving patterns. Then, navigation system 100 plots a route for driver 120 to follow from the starting location to the destination location. During driving, navigation system 100 outputs driving directions at specific times and/or specific positions along the route in order to guide driver 120 in following the route. In addition, navigation system 100 also gathers and generates various contextual data generally associated with navigation and driving of the route, and then scales the level of detail of the driving instructions accordingly. For example, and without limitation, navigation system 100 could determine that a particular portion of the route is well known to driver 120, and could then avoid providing excessive detail which driver 120 may otherwise find distracting. Alternatively, navigation system 100 could determine that driver 120 has not followed the driving instructions sufficiently, indicating that driver 120 could potentially be lost, and could then increase the level of detail of the driving instructions to better assist driver 120 with driving. Navigation system 100 is described in greater detail below in conjunction with FIG. 1B.

As shown in FIG. 1B, computing device 112 within navigation system 100 includes a processor 130, I/O device 132, and a memory 134 that includes a navigation application 136 and a navigation database 138. Processor 130 may be any technically feasible hardware for processing data and executing applications, including, for example and without limitation, a central processing unit (CPU), an application specific integrated circuit (ASIC), a field-programmable gate array (FPGA), among others. I/O devices 132 may include devices for receiving input, such as a global navigation satellite system (GNSS), for example and without limitation, devices for providing output, such as a display screen, for example and without limitation, and devices for receiving input and providing output, such as a touchscreen, for example and without limitation. Memory 134 may be any technically feasible medium configured to store data, including, for example and without limitation, a hard disk, a random access memory (RAM), a read-only memory (ROM), and so forth.

Navigation application 136 is a software application that, when executed by processor 130, implements the overall operation of navigation system 100 discussed herein. When executed, navigation application 136 receives input from driver 120 indicating starting and ending locations for navigation, and then generates one or more routes for driver 120 to follow. Again, navigation system may also receive starting and ending locations from a system configured to estimate or predict those locations. The one or more routes could be generated based on navigation data stored in navigation database 138, for example and without limitation, and could reflect a mathematical graph of nodes and edges derived from a geographic map. Each edge could correspond to a particular driving instruction. Navigation application 136 outputs driving instructions associated with the route to driver 120, via I/O array 114, to guide driver 120 along a selected one of the generated routes.

I/O array 114 includes one or more display devices 140, one or more audio devices 142, and one or more internal sensors 144. Display device(s) 140 could include, for example, and without limitation, a display screen embedded in the dashboard of vehicle 110, a heads-up display projected onto the windshield of vehicle 110, or any other technically feasible type of visual display. Audio device(s) 142 generally includes a speaker array configured to output acoustic signals to driver 120. Internal sensors 144 include various sensors for monitoring driver 120, such as, for example and without limitation, a head tracking unit, an eye gaze tracking unit, a posture sensor, and so forth. I/O array 114 could also include, for example, and without limitation, haptic devices configured to pulse and/or vibrate, mid-air tactile feedback devices, proprioceptive sensory feedback devices, shape-shifting devices, force feedback devices including wearable devices, and so forth.

During navigation, navigation application 136 causes display device(s) 140 to display a map that illustrates some or all of the selected route and/or written driving instructions for following that route. The map could be, for example, and without limitation, an overhead projection or a three-dimensional rendering. Navigation application 136 also causes audio device(s) 142 to output the driving instructions in spoken form. In addition, navigation application 136 may also process various contextual data in order to scale the level of detail of the driving instructions output to driver 120, as mentioned above and as discussed in greater detail below in conjunction with FIG. 1C.

As shown in FIG. 1C, navigation application 136 is configured to obtain and/or generate context data 150, and to then analyze this context data 150 via a level of detail engine 160 (LOD engine). LOD engine 160 processes context data 150 and then selects or generates different subsets of driving instructions 170 having different levels of detail. Subsets 172, 174, and 176 of driving instructions 170 generally represent the same route between the starting location and the destination location, although each subset includes a different level of detail. For example, subset 172 could include highly detailed driving instructions, while subset 176 could include significantly less detailed driving instructions. Based on context data 150, LOD engine 160 determines that a specific subset of driving instructions 170 is most relevant to driver 120, and then outputs driving instructions from that subset to driver 120.

Navigation application 136 may dynamically generate and update context data 150 to include various different types of data, including those shown for exemplary purposes in FIG. 1C, without limitation. In particular, context data 150 could include driver familiarity data which represents a degree to which driver 120 is familiar with the selected route or specific portions o that route. Context data 150 could also include driver instructions, which represent spoken commands received from driver 120. Context data 150 could also include traffic and/or road condition data associated with the selected route. Context data 150 could also include a measure of the degree to which driver 120 deviates from the selected route. Context data 150 could also include sensor data received from I/O array 114 representing the state of driver 120, and/or data from sensor array 116 representing the state of the environment where vehicle 110 drives. Context data 150 could also include other third-party data, such as alternate routes acquired from a cloud-based service, among other possibilities. Although not shown, context data 150 could also include preferences or a profile associated with driver 120, schedule information 120 associated with driver 120, historical information concerning previously driven routes, and so forth. The exemplary context data 150 described herein is provided for illustrative and non-limiting purposes only to reflect the breadth of data LOD engine 160 may rely upon when scaling the level of detail of driving instructions 170.

As a general matter, LOD engine 160 may dynamically scale the level of detail of driving instructions 170 in the manner described above based on some or all of context data 150. Additionally, in certain modes of operation, LOD engine 160 may rely only on specific portions of context data 150 for dynamic scaling purposes.

In one embodiment, when operating in a first mode of operation, LOD engine 160 may compute a familiarity level that represents the degree to which driver 120 is familiar with a current portion of the selected route, as mentioned above. Then, LOD engine 160 may scale the level of detail of driving instructions up or down accordingly. In doing so, LOD engine 160 may analyze historical data to determine whether driver 120 has driven along the selected route (or portion thereof) before. Based on the number of times driver 120 has driven along the route or route portion, LOD engine 160 may select a particular subset of driving instructions 170 having an appropriate level of detail. In computing the familiarity level of driver 120, LOD engine 160 may also rely on addresses driver 120 has visited or input received from driver 120 indicating that certain regions should be considered familiar or non-familiar.

In another embodiment, when operating in a second mode of operation, LOD engine 160 may compute a divergence level that represents the degree to which driver follows or deviates from driving instructions 170. Then, LOD engine 160 may scale the level of detail of driving instructions 170 up or down accordingly. In doing so, LOD engine 160 may determine, for each driving instruction, whether driver 120 successfully followed the instruction. If driver 120 does not follow a threshold number of driving instructions, then LOD engine 160 may select a subset of driving instructions 170 having an increased level of detail in an effort to compensate for the apparent difficulties of driver 120. Alternatively, if driver 120 follows a threshold number of driving instructions, then LOD engine 160 may select a subset of driving instructions 170 having a decreased level of detail in an effort to accommodate the apparent confidence of driver 120. LOD engine 160 may also rely on a ratio between unsuccessfully followed driving instructions and successfully followed driving instructions in this embodiment.

In yet another embodiment, LOD engine 160 may implement the above-described first and second modes in conjunction with one another. In doing so, LOD engine 160 may compute a level of confidence for driver 120 that reflects both the familiarity level associated with the first mode of operation and the divergence level associated with the second mode of operation. For example, and without limitation, LOD engine 160 could calculate the number of times driver 120 has successfully navigated the selected route or route portion, and then also calculate the degree to which driver 120 is currently following the driving instructions associated with the selected route. Then, based on these two calculations, LOD engine 160 could compute a confidence level that reflects, generally, the estimated confidence of driver 120 in following the selected route. LOD engine 160 would then scale the level of detail of the driving instructions in proportion to that confidence level, or select a specific subset of driving instructions based on the confidence level.

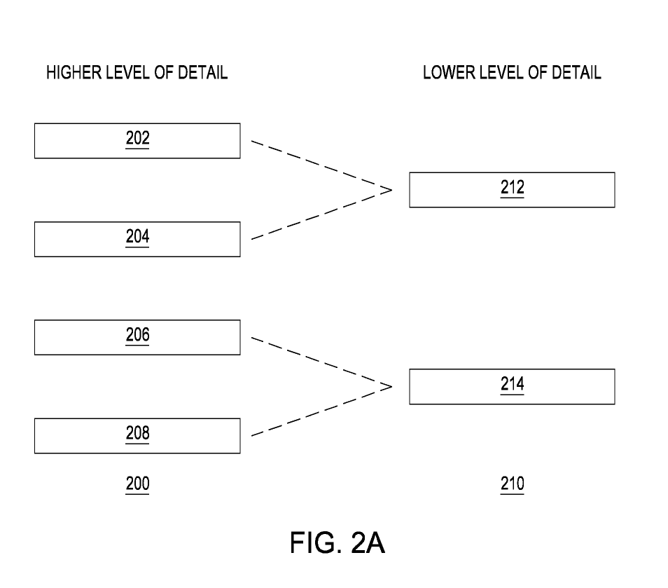

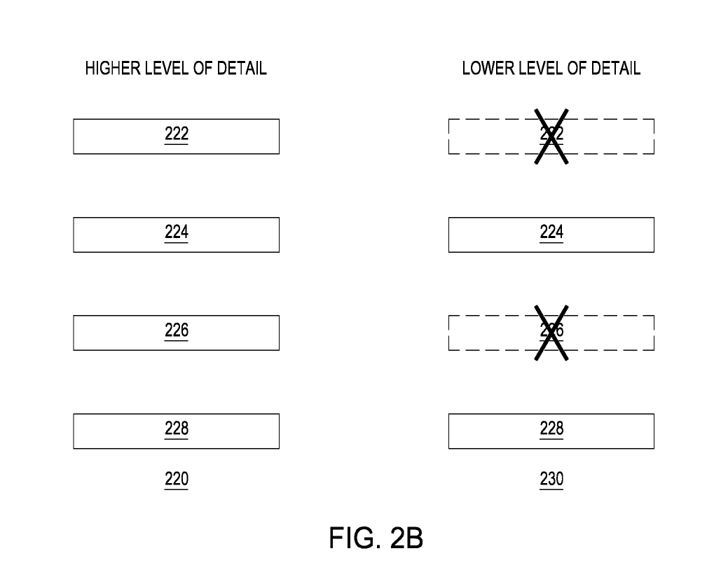

LOD engine 160 is configured to generate subsets of driving directions 170 according to a variety of different techniques. Generally, each subset may include driving instructions having different levels of verbosity, different numbers of driving directions, different frequencies of driving directions, and potentially different ways of presenting those driving instructions. For example, and without limitation, a lower level of detail subset of driving directions could be displayed on a dashboard screen only, while another higher level of detail subset could be displayed on a heads-up display and on the dashboard display. In another example, without limitation, a lower level of detail subset of driving directions could be output with a lower volume and soft tone of voice, while another higher level of detail subset could be output with a higher volume and crisper tone of voice. In practice, LOD engine 160 may simply generate the different subsets of driving directions to have fewer or more driving instructions to reflect different levels of detail, as described in greater detail below in conjunction with FIGS. 2A-2B.

### Changing Level of Detail of Driving Directions

FIGS. 2A-2B illustrate exemplary techniques for changing the level of detail of driving instructions, according to various embodiments. As shown in FIG. 2A, a subset 200 of driving instructions 170 includes driving instructions 202, 204, 206, and 208, while subset 210 of driving instructions 170 includes just driving instructions 212 and 214. Subset 200, having more driving instructions than subset 210, has a higher level of detail or higher granularity than subset 210. Likewise, subset 210, having fewer driving instructions, has a lower level of detail or lower granularity than subset 200. Nonetheless, both subsets 200 and 210 represent the same route from one location to another. In the example discussed herein, subset 200 may represent turn-by-turn driving instructions, while subset 210 may represent high level “fuzzy” driving instructions.

Individual driving instructions within subset 210 may represent multiple driving directions in subset 200 and may be abstractions of the driving directions included in subset 200. As is shown, driving direction 212 in subset 210 is an abstraction of driving directions 202 and 204 and driving direction 214 similarly represents an abstraction of driving directions 206 and 208. An exemplary abstraction of driving directions is provided here for clarity, and is not meant to be limiting. Suppose driving direction 202 indicates that a left turn should be performed, and driving direction 204 indicates that a right turn should be performed in order to arrive at a particular street. Driving direction 212, an abstraction of driving directions 202 and 204, could simply state the driver should drive to the particular street, thereby abstracting away the specific turn-by-turn instructions included in driving directions 202 and 204. An alternative technique for changing the level of detail of driving instructions is presented below in conjunction with FIG. 2B.

In FIG. 2B, a subset 220 of driving instructions 170 includes driving instructions 222, 224, 226, and 228, while subset 230 of driving instructions 170 includes just driving instructions 224 and 228. Subset 220, having more driving instructions than subset 230, has a higher level of detail or higher granularity than subset 230. Likewise, subset 230, having fewer driving instructions, has a lower level of detail or lower granularity than subset 220. Nonetheless, both subsets 220 and 230 represent the same route from one location to another. In the example discussed herein, subset 220 may represent turn-by-turn driving instructions, while subset 230 may represent high level “fuzzy” driving instructions.

LOD engine 160 may generate subset 230 based on subset 220 by simply eliminating or suppressing certain driving instructions that may not be relevant to driver 120 at lower levels of detail. For example, LOD engine 160 could determine that driving direction 222 is not relevant to driver 120 when a lower level of detail is needed, and so LOD engine 120 could suppress that driving direction from subset 230. Driving direction 226 is similarly suppressed in subset 230 because LOD engine 160 deems this direction unnecessary for lower levels of detail. Thus, subset 230 is a lower resolution version of driving directions 220.

### Exemplary Scenarios Where the Level of Detail of Driving Directions is Changed

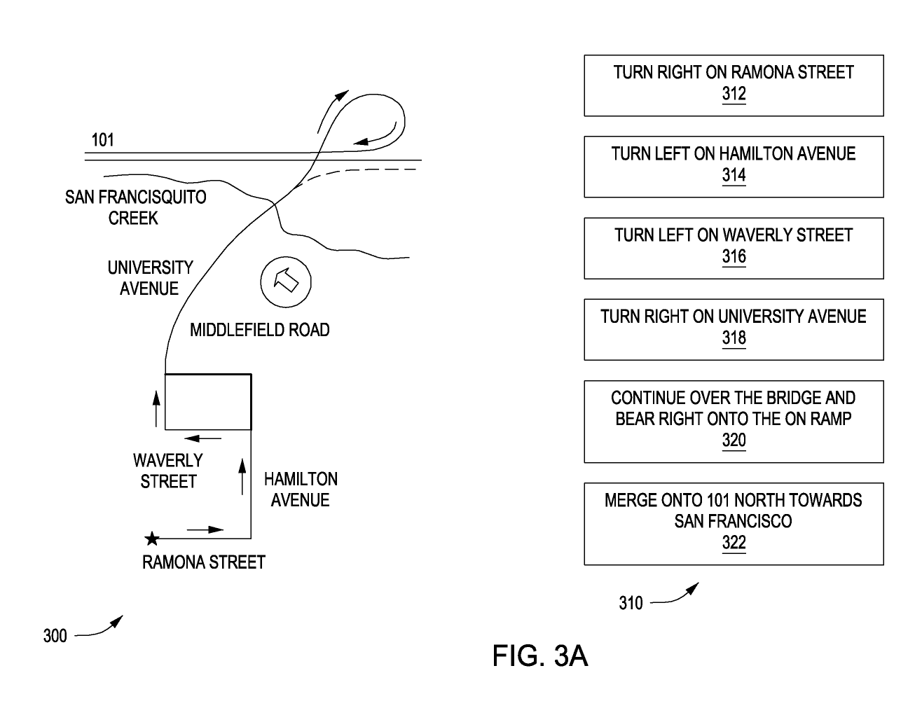

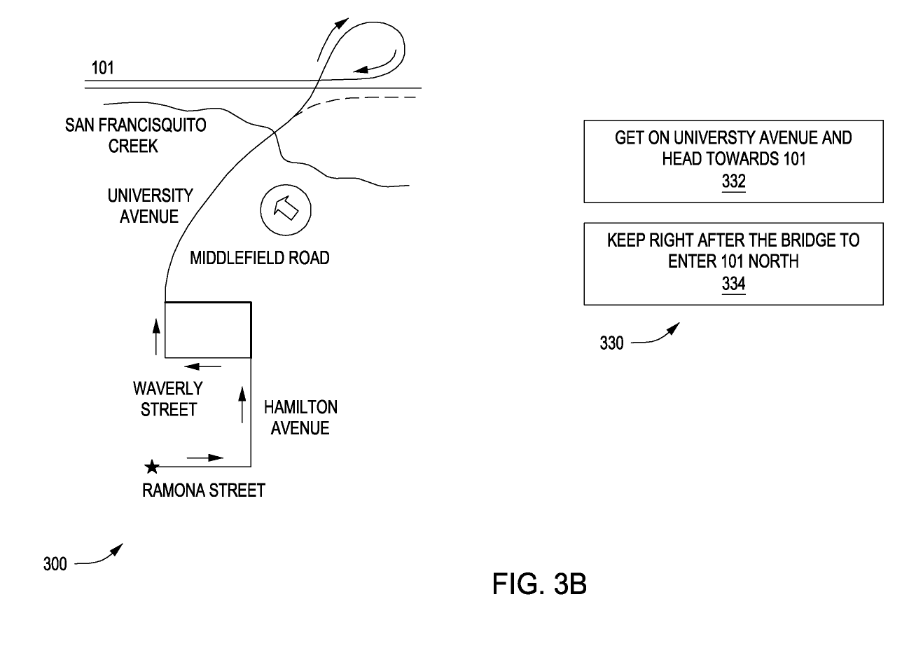

FIGS. 3A-3B illustrate exemplary driving instructions generated by the navigation system of FIG. 1A and having different levels of detail, according to various embodiments. As shown in FIG. 3A, a map 300 is displayed in conjunction with driving directions 310. Map 300 includes a collection of streets within a city that resides adjacent to a freeway. Driving directions 310 includes driving directions 312, 314, 316, 318, 320, and 322. Navigation system 100 is configured to generate map 300 and driving directions 310 in response to driver 120 providing a starting location and a destination location. Navigation system 100 then outputs map 300 and driving instructions 310 to driver 120. For example, and without limitation, navigation system 100 could display map 300 and driving directions 310 on display device 140 within I/O array 114. Alternatively, navigation system 100 could output driving directions 310 sequentially via audio device 142 within I/O array 114.

In the example discussed herein, driving directions 310 represent highly granular driving instructions having a high level of detail. In particular, driving instructions 310 are turn-by-turn directions indicating the exact sequence of navigation maneuvers that need to be performed in order to navigate from the starting location (shown as a star) to the freeway. As discussed above in conjunction with FIGS. 1A-2C, navigation system 100 is configured to scale the level of detail of the driving instructions presented to driver 120 based on a variety of contextual factors, that may represent driver familiarity, divergence from driving instructions, overall driver confidence, and so forth. FIG. 3B illustrates driving instructions having a lower level of detail than those shown in FIG. 3A.

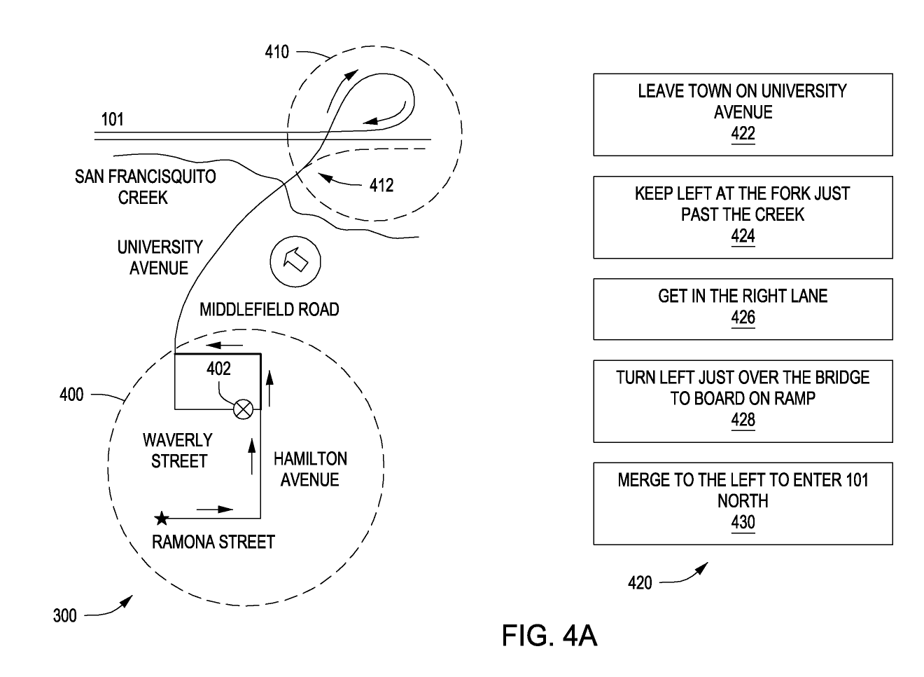

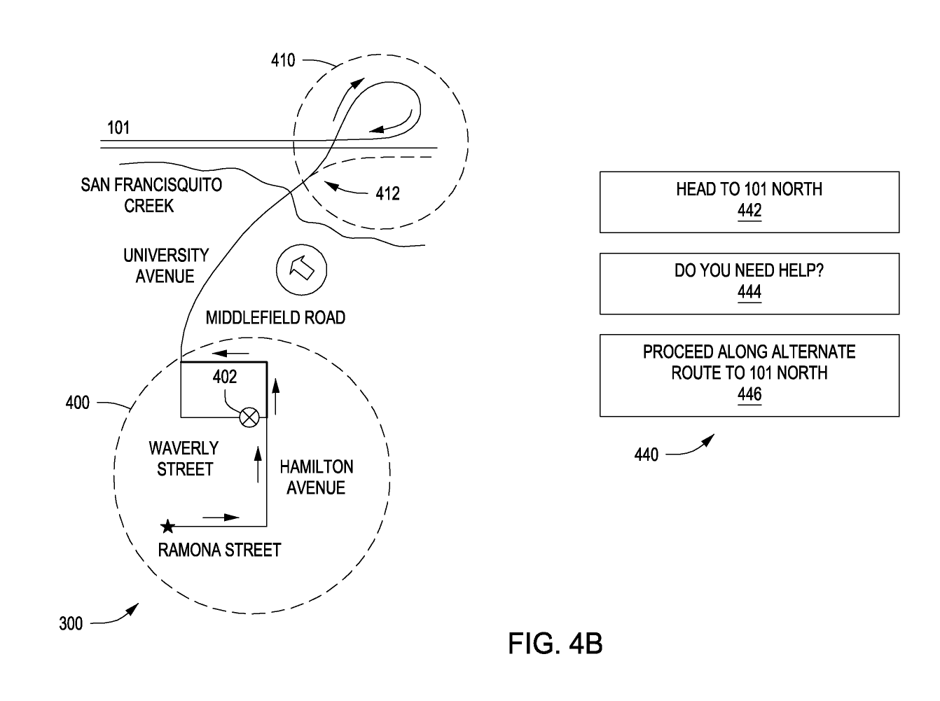

As shown in FIG. 3B, map 300 is displayed in conjunction with driving instructions 330. Driving instructions 330 are a less granular version of driving instructions 310 discussed above in conjunction with FIG. 3A and therefore have a lower level of detail. However, driving instructions 330 still represent the same route as that associated with driving instructions 310. Specifically, both of driving instructions 310 and 330 instruct driver how to navigate from the starting location to the freeway. In addition to being less verbose, driving instructions 330 have a more casual tone which driver 120 may find easier to process than the highly detailed instructions included in driving instructions 310. Thus, the cognitive load on driver 120 when receiving driving instructions 330 from navigation system 100 may be reduced when a lower level of detail is employed. Navigation system 100 is configured to scale the level of detail of the driving instructions output to driver 120, and potentially select between subsets of driving instructions, based on a variety of different types of contextual data, as discussed below in conjunction with FIGS. 4A-4B.

FIGS. 4A-4B illustrate exemplary driving instructions scaled by the navigation system of FIG. 1A and having dynamic levels of detail, according to various embodiments. As shown in FIG. 4A, map 300 includes a city region 400 and a freeway region 410. City region 400 includes an obstruction 402, which is discussed below in conjunction with FIG. 4B. Freeway region 410 includes a fork 412, described in greater detail herein. Navigation system 100 is configured to generate driving instructions 420, which include individual driving instructions 422, 424, 426, 428, and 430.

Driving instruction 422 is a low level of detail driving instruction that generally indicates that driver 120 should leave the city using a particular street. Navigation system 100 may direct driver 120 in this manner upon determining that driver 120 is familiar with region 400. For example, and without limitation, navigation system 100 could analyze the driving history of driver 120 and determine that driver 120 has successfully exited region 400 in the manner needed a number of previous times. Thus, navigation system 100 would determine that driver 120 does not require highly detailed, turn-by-turn instructions in order to exit the city. Alternatively, driver 120 could indicate to navigation system 100 that detailed instructions are not needed within region 400.

Driving instructions 424, 426, 428, and 430, on the other hand, are highly detailed, turn-by-turn directions that specifically indicate a sequence of maneuvers needed to properly navigate within region 410. Navigation system 100 may employ a higher level of detail for navigation of region 410 for any number of different reasons. For example, and without limitation, navigation system 100 could determine that driver 120 historically makes navigation errors within region 410. Alternatively, navigation system 100 could determine that driver 100 has begun to deviate from the selected route after leaving region 400, and in response to this deviation, increase the level of detail of driving instructions 420.

Navigation system 100 could also identify that driver 120 specifically, or drivers in general, typically follow the right-hand street at fork 412 by accident and therefore deviate from the current route. In anticipation of this error, navigation system 100 could increase the level of detail of driving instructions 420 and specifically provide driving instruction 424 to assist driver 120 in avoiding this potential mistake. Navigation system 100 may interact with driver 120 in response to changes in the behavior of driver 120 as well. These changes could be reflected in the familiarity level of driver 120, the divergence level, and/or the confidence level of driver 120, as computed by navigation system 100. An example of these interactions is described in conjunction with FIG. 4B.

As shown in FIG. 4B, navigation system 100 generates driving instruction 442 indicating that driver 120 should generally leave the city along a certain street. Navigation system 100 also plots a detailed route, such as that described by driving instructions 310 shown in FIG. 3A. However, navigation system 100 also determines that driver 120 is familiar with city region 400 and likely does not require such detailed instructions. During navigation out of city region 400, obstruction 402 causes driver 120 to drive along a slightly different route than the one generated by navigation system 100. Navigation system 100 detects this slight divergence from the original route. Because navigation system 100 has already determined that driver 120 is familiar with city region 400, navigation system 100 may not immediately adjust the level of detail of driving instructions 440. Instead, navigation system 100 prompts driver 120, via driving instruction 444, to confirm that driver 120 remains confident in navigating out of city region 400. Based on the response of driver 120 to this prompt, navigation system 100 may scale the level of detail of driving instructions up or down, or do nothing. In the example shown, navigation system 100 simply confirms that driver 120 is taking an alternate route.

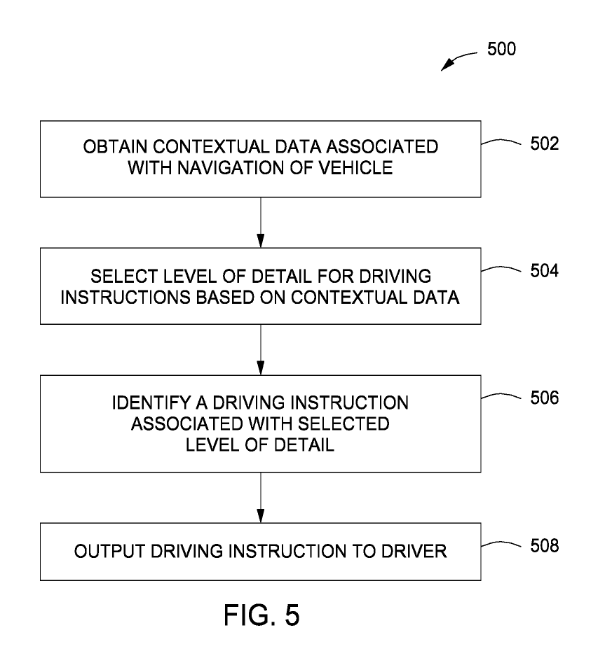

Referring generally to FIGS. 3A-4B, persons skilled in the art will recognize that the various examples discussed in conjunction with these figures are meant for illustrative and non-limiting purposes only to show how navigation system 100 scales the level of detail of driving instructions relative to various information. FIGS. 5-8 describe, in more general terms, the overall operation of navigation system 100.

### Navigation System Operation

FIG. 5 is a flow diagram of method steps for scaling the level of detail of driving directions based on contextual data, according to various embodiments. Although the method steps are described in conjunction with the systems of FIGS. 1-4B, persons skilled in the art will understand that any system configured to perform the method steps, in any order, is within the scope of the disclosed embodiments.

As shown, a method 500 begins at step 502, where navigation system 100 obtains contextual data associated with the navigation of vehicle 110. The contextual data obtained at step 502 could be, for example and without limitation, context data 150 described above on conjunction with FIG. 1C. The contextual data could also include additional data not specifically discussed in conjunction with FIG. 1C, including data received from a system external to navigation system 100. Navigation system 100 may generate some or all of the contextual data, and may dynamically update that data over time.

At step 504, navigation engine 100 selects a level of detail for driving instructions based on the contextual data obtained at step 502. Navigation system 100 generally selects a level of detail that is appropriate for driver 120 via LOD engine 160 and thereby provides a relevant amount of information for assisting driver 120 with navigation.

At step 506, navigation system 100 identifies a driving instruction associated with the selected level of detail. In one embodiment, navigation system 100 may select between different subsets of driving instructions, as described above in conjunction with FIG. 1C, and then select a driving instruction associated with the current location of vehicle 110 and driver 120.

At step 508, navigation system 100 outputs the driving instruction to driver 120. In doing so, navigation system 100 may cause I/O array 114 to display the driving instruction and/or generate acoustic signals that represent spoken language, among other techniques for outputting data to driver 120.

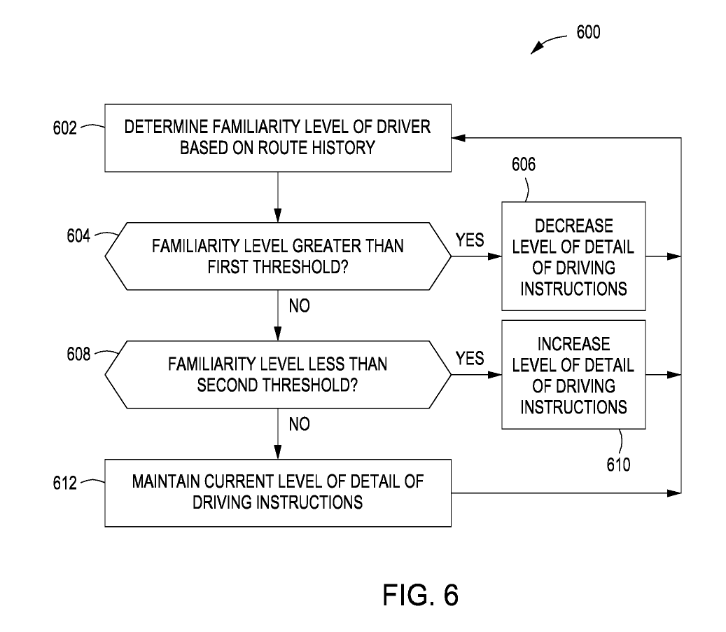

Navigation system 100 may perform the method 500 repeatedly in order to identify proper levels of detail and then provide relevant driving instructions to driver 120. In performing the method 500, navigation system 100 may also perform additional methods described below in conjunction with FIGS. 6-8.

FIG. 6 is a flow diagram of method steps for scaling the level of detail of driving directions based on a familiarity level associated with a driver of a vehicle, according to various embodiments. Although the method steps are described in conjunction with the systems of FIGS. 1-4B, persons skilled in the art will understand that any system configured to perform the method steps, in any order, is within the scope of the disclosed embodiments.

As shown, a method 600 begins at step 602, where navigation system 100 determines a familiarity level for driver 120 based on the route history associated with driver 120. Navigation system 100 records each route that driver 120 navigates and may process this historical data to determine the number of times driver 120 has successfully driven the current route. Navigation system 100 computes the familiarity level based on the number of successful navigations of the current route.

At step 604, navigation system 100 determines whether the familiarity level determined at step 602 is greater than a first threshold. If the familiarity level is greater than the first threshold, then navigation system 100 proceeds to step 606 and decreases the level of detail of the driving instructions. The method 600 may then repeat. At step 604, if the familiarity level does not exceed the first threshold, then navigation system 100 does not decrease the level of detail of the driving instructions and instead proceeds to step 608. The first threshold generally represents an upper limit to the familiarity level, where beyond that threshold navigation system 100 determines that driver 120 is sufficiently familiar with the current route that the level of detail can be safely reduced.

At step 608, navigation system 100 determines whether the familiarity level determined at step 602 is less than a second threshold. If the familiarity level is less than the second threshold, then navigation system 100 proceeds to step 610 and increases the level of detail of the driving instructions. The method 600 may then repeat. At step 608, if the familiarity level does not fall beneath the second threshold, then navigation system 100 does not increase the level of detail of the driving instructions and instead proceeds to step 612. The second threshold generally represents a lower limit to the familiarity level, where beneath that threshold navigation system 100 determines that driver 120 is unfamiliar with the current route and the level of detail needs to be increased.

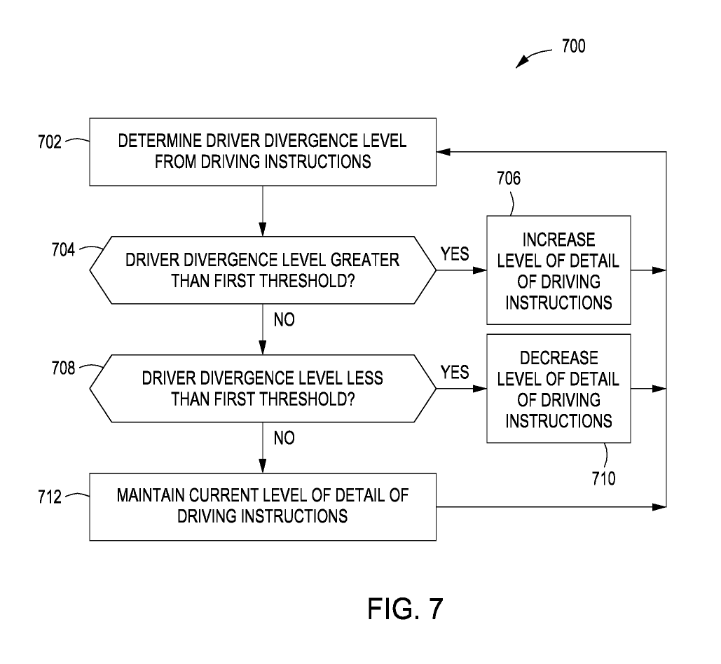

At step 612, navigation system 100 maintains the current level of detail for the driving instructions. Navigation system 100 performs step 612 when the familiarity level is between the first and second thresholds. In other embodiments, only one threshold may be implemented to increase and decrease the level of detail of the driving instructions. Navigation system 100 may also scale the level of detail based on the degree to which driver 120 diverges from the driving instructions, as described below in conjunction with FIG. 7.

FIG. 7 is a flow diagram of method steps for scaling the level of detail of driving directions based a degree to which a driver of a vehicle diverges from the driving directions, according to various embodiments. Although the method steps are described in conjunction with the systems of FIGS. 1-4B, persons skilled in the art will understand that any system configured to perform the method steps, in any order, is within the scope of the disclosed embodiments.

As shown, a method 700 begins at step 702, where navigation system 100 determines a divergence level for driver 120 that reflects the degree to which driver 120 successfully completes the driving instructions for the current route. For example, and without limitation, if navigation system 100 instructs driver 120 to make a particular turn, and driver 120 does not successfully make the turn, then navigation system 100 would determine that driver 120 has diverged from the driving instructions and increase the divergence level of driver 120. Similarly, if driver 120 instead successfully makes the turn, then navigation system 100 would determine that driver 120 has not diverged from the driving instructions and could decrease the divergence level of driver 120.

At step 704, navigation system 100 determines whether the divergence level determined at step 702 is greater than a first threshold. If the divergence level is greater than the first threshold, then navigation system 100 proceeds to step 706 and increases the level of detail of the driving instructions. The method 700 may then repeat. At step 704, if the divergence level does not exceed the first threshold, then navigation system 100 does not increase the level of detail of the driving instructions and instead proceeds to step 708. The first threshold generally represents an upper limit to the divergence level, where beyond that threshold navigation system 100 determines that driver 120 has sufficiently diverged from the current route and may need additional detail in order to continue navigation.

At step 708, navigation system 100 determines whether the divergence level determined at step 702 is less than a second threshold. If the divergence level is less than the second threshold, then navigation system 100 proceeds to step 710 and decreases the level of detail of the driving instructions. The method 700 may then repeat. At step 708, if the divergence level does not fall beneath the second threshold, then navigation system 100 does not increase the level of detail of the driving instructions and instead proceeds to step 712. The second threshold generally represents a lower limit to the divergence level, where beneath that threshold navigation system 100 determines that the driver adheres to the current route sufficiently and the level of detail can be safely reduced.

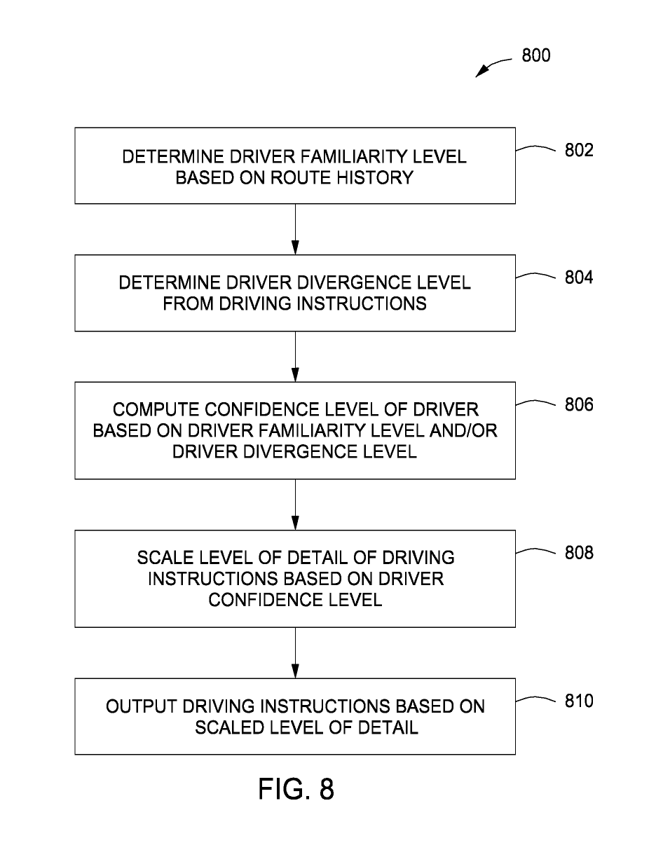

At step 712, navigation system 100 maintains the current level of detail for the driving instructions. Navigation system 100 performs step 712 when the divergence level is between the first and second thresholds. In other embodiments, only one threshold may be implemented to increase and decrease the level of detail of the driving instructions. Navigation system 100 may also scale the level of detail based on a confidence level assigned to driver 120 that is based, at least in part, on a familiarity level and a divergence level computed for driver 120, as discussed below in conjunction with FIG. 8.

FIG. 8 is a flow diagram of method steps for scaling the level of detail of driving directions based on both a familiarity level associated with a driver of a vehicle and a degree to which the driver diverges from the driving instructions, according to various embodiments. Although the method steps are described in conjunction with the systems of FIGS. 1-4B, persons skilled in the art will understand that any system configured to perform the method steps, in any order, is within the scope of the disclosed embodiments.

As shown, a method 800 begins at step 802, where navigation system 100 determines a familiarity level for driver 120 based on the route history of driver 120. Step 802 of the method 800 may be substantially similar to step 602 of the method 600 described above.

At step 804, navigation system 100 determines a divergence level for driver 120 based on how closely driver 120 follows the current driving instructions. Step 804 of the method 800 may be substantially similar to step 702 of the method 700 described above.

At step 806, navigation system 100 computes a confidence level for driver 120 based on the familiarity level determined at step 802 and/or the divergence level determined at step 804. The confidence level computed at step 806 represents a general measure of the predicted degree to which driver 120 can follow the driving instructions.

At step 808, navigation system 100 scales the level of detail of the driving instructions based on the confidence level computed at step 806. In doing so, navigation system 100 may select between subsets of driving instructions, suppress or un-suppress certain driving instructions, or perform any of the various techniques described above for changing the granularity of the driving instructions.

At step 810, navigation system 100 outputs driving instructions to driver 120 with the scaled level of detail. Navigation system may rely on I/O array 114 to perform step 810 in the manner described previously.

In sum, a navigation system is configured to monitor various contextual data associated with the driving and navigation of a vehicle, and to scale the level of detail of driving instructions based on that contextual data. In doing so, the navigation system may estimate a level of familiarity that a driver of the vehicle has with a current route, and then identify and/or determine a degree to which the driver of the vehicle diverges from the current driving instructions. Based on either one of, or both, of the familiarity level and the divergence level, the navigation system scales the level of detail of the driving instructions so that the driver is provided with an appropriate amount of information.

At least one advantage of the disclosed techniques is that the driver of the vehicle is not subjected to superfluous driving direction detail while driving that could otherwise be distracting. Thus, scaling the level of detail in one or more of the manners described herein may provide a safer approach to assisting drivers with navigation. In addition, because the driver can scale the level of detail via interactions with the navigation system, the driver can ensure that the appropriate amount of information is available to him or her while driving.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable processors.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

1. A non-transitory computer-readable medium storing instructions that, when executed by a processor, configure the processor to provide driving instructions to a driver of a vehicle, by performing the steps of:
generating an initial set of driving instructions for navigating the vehicle along a route;
generating contextual data associated with navigating the route;
scaling a level of detail associated with the initial set of driving directions based on the contextual data to generate a second set of driving instructions for navigating the vehicle along the route; and
transmitting the second set of driving instructions to the driver.

2. The non-transitory computer-readable medium of claim 1, wherein generating the contextual data comprises determining a number of times the route has been previously driven by the driver.

3. The non-transitory computer-readable medium of claim 1, wherein generating the contextual data comprises determining a number of driving instructions in the initial set of driving instructions that have not been successfully followed while navigating the vehicle along the route.

4. The non-transitory computer-readable medium of claim 1, wherein generating the contextual data comprises receiving input that represents a target level of detail for the second set of driving instructions.

5. The non-transitory computer-readable medium of claim 1, wherein generating the contextual data comprises determining at least one of traffic conditions and road conditions associated with the route.

6. The non-transitory computer-readable medium of claim 1, wherein scaling the level of detail associated with the initial set of driving instructions comprises suppressing at least one driving instruction in the initial set of driving instructions to generate the second set of driving instructions.

7. The non-transitory computer-readable medium of claim 1, wherein scaling the level of detail associated with the initial set of driving instructions comprises un-suppressing at least one previously suppressed driving instruction in the initial set of driving instructions to generate the second set of driving instructions.

8. The non-transitory computer-readable medium of claim 1, wherein the route comprises a mathematical graph of nodes, and each driving instruction in the initial set of driving instructions corresponds to a different edge between two nodes in the graph of nodes.

9. The non-transitory computer-readable medium of claim 8, wherein scaling the level of detail of the driving instructions comprises suppressing or un-suppressing a first driving instruction associated with a first edge in the mathematical graph of nodes.

10. A computer-implemented method for providing driving instructions to a driver of a vehicle, the method comprising
generating an initial set of driving instructions for navigating the vehicle along a route;
generating contextual data associated with navigating the route;
scaling a level of detail associated with the initial set of driving directions based on the contextual data to generate a second set of driving instructions for navigating the vehicle along the route; and
transmitting the second set of driving instructions to the driver.

11. The computer-implemented method of claim 10, wherein generating the contextual data comprises determining a number of repetitions with which the driver has driven the route.

12. The computer-implemented method of claim 10, wherein generating the contextual data comprises determining a ratio between a number of driving instructions in the initial set of driving instructions that have not been successfully followed while navigating the vehicle along the route and a number of driving instructions in the initial set of driving instructions that have been successfully followed while navigating the vehicle along the route.

13. The computer-implemented method of claim 10, wherein generating the contextual data comprises determining at least one of traffic conditions and road conditions associated with the route.

14. The computer-implemented method of claim 10, wherein scaling the level of detail associated with the initial set of driving instructions comprises removing at least one driving instruction from the initial set of driving instructions to generate the second set of driving instructions.

15. The computer-implemented method of claim 10, wherein scaling the level of detail associated with the initial set of driving instructions comprises adding at least one driving instruction to the initial set of driving instructions to generate the second set of driving instructions.

16. The computer-implemented method of claim 10, wherein the route comprises a mathematical graph of nodes, and each driving instruction in the initial set of driving instructions corresponds to a different edge between two nodes in the graph of nodes, and wherein scaling the level of detail of the driving instructions comprises suppressing or un-suppressing a first driving instruction associated with a first edge in the mathematical graph of nodes.

17. A system for providing driving instructions to a driver of a vehicle, comprising:
a memory storing a navigation application; and
a processor coupled to the memory that, when executing the navigation application, is configured to:
generate an initial set of driving instructions for navigating the vehicle along a route,
generate contextual data associated with navigating the route,
scale a level of detail associated with the initial set of driving directions based on the contextual data to generate a second set of driving instructions for navigating the vehicle along the route, and
transmit the second set of driving instructions to the driver.

18. The system of claim 17, wherein the processor is configured to generate the contextual data by determining a number of times the route has been previously driven by the driver.

19. The system of claim 17, wherein the processor is configured to generate the contextual data by determining a number of driving instructions in the initial set of driving instructions that have not been successfully followed while navigating the vehicle along the route.
